(19) United States
(12) Patent Application Publication
(10) Pub. No.: US 2010/0198926 A1
(43) Pub. Date: Aug. 5, 2010

(54) Method and an apparatus for providing more of the same

(75) Inventors: John Hammer Madsen, Holstebro (DK); Søren Borup Jensen, Struer (DK)

Correspondence Address: HARNESS, DICKEY & PIERCE, P.L.C., P.O. BOX 8910, RESTON, VA, 20195, US

(73) Assignee: Bang & Olufsen A/S

(21) Appl. No.: 12/656,591

(22) Filed: Feb. 4, 2010

Related U.S. Application Data
(60) Provisional application No. 61/213,025, filed on Apr. 29, 2009.

(30) Foreign Application Priority Data
Feb. 5, 2009 (DK) PA 2009-00184

(51) Int. Cl. G06F 15/16

(52) U.S. Cl. 709/206

(57) ABSTRACT

A system and a method where a client, which usually is portable, derives information relating to an event experienced by a user and communicates this event information to one or more providers which return with information relating to corresponding or similar events. In one situation, the client stores the event information if communication with the providers is not possible, such as if the client is out of reach of a wireless network. In another situation, the providers may store the event information and act as search agents performing searches also in the future on the basis of the event information.

### CLAIM FOR PRIORITY

This application claims priority to Danish Patent Application No. PA 2009-00184 filed on Feb. 5, 2009 and U.S. Provisional Application No. 61/213,025 filed Apr. 29, 2009 in the U.S. Patent and Trademark Office, the contents of each of which are incorporated herein in their entirety.

The present invention relates to a method and a system for providing events to a user and in particular to a technology where relevant or interesting events may be sought for or obtained from remote apparatus. In this context, relevant or interesting events are events similar to one identified by a user, such as when using a desired manner of comparing events.

Technologies of this type may be seen in: U.S. Pat. No. 7,500,007, US2008/256115, US2006/106867, WO2006/025797, US2004/143349, Gracenote_Mobile MusicID (http://www.gracenote.com/business_solutions/mobileMusic/), WO2007/053770, and US2009/0063627.

In a first aspect, the invention relates to a method of providing events to a user, the method comprising:
1. providing a client available to the user and one or more providers,
2. each provider accessing information relating to a plurality of events, for each event, the information relates to parameters derived from the event by a predetermined analysis,
3. the client holding ID information identifying one or more of the provider(s),
4. the client identifying an event,
5. forwarding event information relating to the identified event to one or more of the provider(s) identified by the ID information,
6. the provider(s) identifying events corresponding to the forwarded event information and returning information identifying the identified events, and
7. the client receiving the identifying information and informing the user of the identified events,
   the method further comprising a step, prior to steps 5 and 6, of determining whether communication between the client and provider(s) is possible and, if not, step 4 comprises storing the event information, until communication is possible.

In this respect, an event may be any type of event which a user may experience, such as visual or audio information, which may be music, video, text, images, or the like. Often, an event is a file of a particular format, such as tiff, mpeg, mp3, mp4, WMA etc. Alternatively, the event may be streamed, also normally in a defined format.

The client and the provider(s) may be individual media players, such as stand-alone media players, such as a standard MP3-player, or may each form part of equipment also having other functions, such as a cell phone, a PDA, an eBook, a PC, a server, a storage element, a TV, an AV system or the like. Naturally, the client and providers need not be of the same type. Thus, the client may be a TV/stereo/media player while the providers may be PC's, servers, storage units or the like.

The client and provider(s) communicate with each other. Naturally, any type of communication and any communicating means may be used, such as any networking elements, such as NIC's, network adapters, wireless communication devices, routers, switches, Bluetooth elements, IR communication elements, computers or servers, thin clients or the like, and the communication may be under any desired protocol (Ethernet, Bluetooth, IR or the like) and on any desired medium, such as wireless, intra nets, the WWW, WANs, LANs or the like, or any combination thereof.

Naturally, this communication may be only that required to operate the method and system, but normally this communication is set up also with other information.

A number of clients may be provided which all forward event information to all of or some of the providers (as identified in the ID information of each client), whereby the providers may be remote providers accessible over the WWW. Also, the providers may be client type apparatus or functions in that they may themselves be accessible to other users and be adapted to have events identified by the respective user.

In the present context, events and/or information may be stored in or be available or accessible from a number of sources, such as from a near-by or internal storage, a remote storage, via a network of any type, or by being fed from an external source, such as via the WWW, DAB, DVD, CD, net radio or via airborne signals, such as TV or radio signals. Naturally, the storage may be a memory card, RAM, ROM, PROM, EPROM, EEPROM, hard disc Flash, tape, disc, card, electrical, magnetic, or optical, or the like or may be one or more CD-ROM/DVD discs the contents of which is made available.

Also, event information, which may be seen as a seed for the identification of similar events, may be any type or piece of information describing the event or something connected thereto. Different standards exist for different types of events, such as the ID3.v2 standard for audio files and EXIF for video. Such event information may be: author, artist, group, name, title, producer, date/year of production/issuance/birth, genre, theme, pace/beats-per-minute, played recently/never, most/never/recently used, oldies, or the like. In addition, event information may be a type of file in which the event is stored (tiff, mpeg, mp3, mp4, WMA etc.). Thus, the analysis may be an analysis based on the above data.

Preferably, however, as will be described further below, when the event is music or audio, an analysis is performed by the client based on the actual contents of the event, such as the analysis described in WO2006/050731. In this manner, the actual contents, such as the BPM, key, overall musical timbre and/or rhythmical elements, may be used for characterizing the event.

Similarity or correspondence between parameters/information may be defined in any desired manner. If the parameter/information is a number, an interval or percentage may be defined within which parameters/information may be taken to be similar. Similarity/correspondence between persons may be similarity in gender, age, place/country of birth, citizenship, religion, skin colour, education, taste, sexuality, or the like.

As to the instruments used, the same type of identity and similarity described above for artists may be used.

A particularly suitable manner of estimating or determining identity or similarity is one in which a space is defined having a number of dimensions corresponding to a number of parameters of the information. Then, identity or correspondence/similarity may be estimated on the basis of a distance or angle between points or vectors defined in the space by the parameter(s) of the individual events. The closer or the lower the angle, the more similar the events.

The analysis of the event, and the controlling of the client and/or provider may be performed by any type of circuit, processor or the like, hardwired or software controlled or a combination thereof. Thus, ASICs, general purpose processors, digital signal processors, FPGAs or the like may be used.

In this respect, it is noted that it could be preferable to allow the user to select different types of similarity/correspondence, such as by providing one of a number of predetermined or predefined selections of information/parameters on the basis of which the similarity is estimated. Thus, the user may either determine on the basis of which information/parameter(s) the similarity determination is to be performed or select one or a number of predetermined parameters or groups of parameters of the information. One group of parameters may relate to the artist and label. Another group of parameters may relate to beats per minute and key. Other parameter groups may relate to year or decade of production and beats per minute or group. Infinite possibilities exist for the user to customize this determination or for customizing predefined groups of parameters which are subsequently selected by the actual input made.

The identifying information may be any type of information identifying or describing the identified events, such as the events themselves, such as compiled into a playlist, metadata describing the events (title, artist, author, date of production or the like), or links (URL or the like) to sites, computers, network elements, databases, servers, storages or the like, where the event(s) may be obtained, accessed, downloaded or the like.

Having now received the identifying information, the user is informed thereof, and a number of possibilities now exist. If the identified events are available to the user, these events may be received or accessed for the user to experience. Instead, the user could be informed of the events and him/herself select which to access. Alternatively, the events may be available only by purchase/leasing or the like. Then, the user may be suggested to purchase/lease one or more of these events. In the end, the events may be added to a group of events, such as a playlist, if the events are audio/video.

The method further comprises a step, prior to steps 5 and 6, of determining whether communication between the client and provider(s) is possible and, if not, step 4 comprises storing the event information until communication is possible. The lack of or preventing of communication may be accidental, such as if a connection to the WWW is lost for some reason, or intentional, such as if the connection or communication is broken between the client, if portable, and a network or docking station connecting the client to the provider(s). This last situation may be that of an MP3-player or the like, which may be used “off line” while travelling or jogging, e.g.; and “on-line” where it is docked or connected to an intranet, a computer, a network or the like. The same situation may be that of a car stereo which, when the car is parked in the owner's garage, accesses the user's/owner's wireless network and thus communicates and which is out of reach of the network when on the road.

When not docked/communicating, the client may have limited functionality compared to the functionality obtained when docked/communicating. One such missing functionality may be the swift or immediate transmission of event information relating to an identified event, whereas the user may be allowed to always identify events, while the client is docked/communicating. When docked/communicating, the client may be synchronized, have events downloaded, be charged or the like, and/or transfer the event information to the provider(s). Also, identifying information may be transmitted to the client only when docked/communicating.

Thus, determining whether communication is possible may be to determine whether a network, a computer, a docking station or the like is within reach. Alternatively, especially when the communication is based on wireless communication, the client may be equipped with GPS or similar capabilities, whereby the determination may simply be based on the whereabouts of the client. If the client is sufficiently close to e.g. the user's house/network/router, the communication will be possible.

If communication is not possible, the event information is stored, until communication is possible, where after the event information is transmitted as intended in the first place.

Naturally, event information of any number of events may be stored and communicated when possible.

In one embodiment, the event information forwarded by the client may be information received by the client, such as metadata (title etc) transmitted to the client together with the event or even all of or part of the event itself (such as copying a part of the event), whereby the provider(s) may be adapted to identify similar events from the information transmitted.

Alternatively, step 4. may comprise the client deriving one or more parameters from the identified event using the predetermined analysis, and wherein the event information comprises the parameter(s) derived.

When the same analysis, or at least parameters describing the same features of the events, is used, comparison of the events and thus similarity or correspondence there between is made easy. Also, if the client is able to perform analysis, the client may identify similar events directly available to the client and combine these with the identified events to obtain a complete e.g. list of events similar to the event identified by the user.

In a particularly interesting embodiment, step 4. comprises the client receiving the event as a streamed event and simultaneously deriving the one or more parameters.

Streaming sources may be e.g. the WWW, DAB, CD, DVD, net radio or standard, airborne radio/TV signals, usually originated remotely from the client and not controllable by the client or user.

Then, preferably a real time analysis of the streamed event is performed in order to determine the one or more parameters. In this connection, the real time analysis is preferably an analysis performed after the user has identified the event and while the actual event is being received.

Alternatively, the event may have been pre-analyzed so that the parameter(s) of the provided event are already known and so that no real-time analysis thereof is required.

In this respect, it may be desired or required to not store the actual streamed event. This may be for a number of reasons, such as that the user does not have the right to do so, or that only part of the event can be stored (only a part thereof is streamed or the user was not aware of it before part of it was already streamed). However, in order for the user to be able to identify corresponding events, the parameters may be stored. Normally, the full event cannot be re-created from only a part thereof (but it can normally be identified), but the parameters preferably comprise sufficient information for the actual event or similar or corresponding events to be identified.

Naturally, it is preferred that the user or client gains access to one or more of the identified events. This could be receiving these as streamed events, downloading or otherwise accessing these, possibly by paying a royalty or fee.

A second aspect of the invention relates to a method of providing events to a user, the method comprising:
1. providing a client available to the user and one or more providers,
2. each provider accessing information relating to a plurality of events, for each event, the information relates to parameters derived from the event by a predetermined analysis,
3. the client holding ID information identifying one or more of the provider(s),
4. the client identifying an event,
5. forwarding event information relating to the identified event to one or more of the provider(s) identified by the ID information,
6. the provider(s) identifying events corresponding to the forwarded event information and returning information identifying the identified events, and
7. the client receiving the identifying information and informing the user of the identified events,
   wherein step 6. comprises the provider(s) storing the forwarded parameter(s) and, at a later point in time, receiving additional information relating to additional events, identifying one or more of the additional events having parameters corresponding to the forwarded parameter(s) and returning information identifying the identified, additional events.

Naturally, all the above descriptions etc. of the individual elements and step relating to the first aspect are equally valid in relation to the second aspect of the invention.

An advantage of this second aspect is that a searching agent may be provided which is active on the provider(s) and is activated when receiving or accessing new events. Then, the agent will determine whether any of these new events correspond to the request made and, if so, inform the user of the new event. Naturally, the later point in time may be any period of time after the receipt of the forwarded parameter(s) from the client, and the request or information may be allowed to lapse or expire after a predetermined or user-input period of time, in order to keep the overall number of such requests to an acceptable level. The same client or the same user may, naturally, have any number of such requests at any number of provider(s).

In a preferred embodiment, the method further comprises the final step of the client gaining access to one or more of the identified events.

In another aspect, the invention relates to a system for providing events to a user, the system comprising:
1. a client and one or more providers, the client and provider(s) being adapted to communicate with each other,
2. each provider comprising means for accessing information relating to a plurality of events, for each event, the information relates to parameters derived from the event by a predetermined analysis,
3. the client comprises means for holding ID information identifying one or more of the provider(s),
4. the client comprising means for having an event identified and for forwarding event information relating to the identified event to one or more of the provider(s) identified by the ID information,
5. the provider(s) comprising means for identifying events corresponding to the forwarded event information and for returning information identifying the identified events, and
6. the client comprising means for receiving the identifying information and informing the user of the identified events
   the system further comprising means for determining whether communication is possible between the client and provider(s) and, if not, storing the event information, until communication is possible.

An event may be identified in any suitable manner, such as the user inputting a type of information. The input may be tactile, such as detectable via buttons, a touch screen, a joystick, a rotatable wheel or the like, or be adapted to be received and interpreted as audio commands. Alternatively or in addition, the user may input information by moving the client or a part thereof in relation to him/herself or the surroundings, when movement detection means are provided. The input may be the name/title or other information identifying an event or may be a simple pushing of a button, when the event is provided or during the providing thereof.

In one embodiment, the client further comprises means for deriving one or more parameters from the identified event using the predetermined analysis, the event information comprising the parameter(s) derived.

As mentioned above, communication may not always be possible, and if not possible, this is detected or determined, whereby the event information is stored. Then, once the determining means determines that communication is again possible, the event information may be transmitted and identifying information received.

This determination of whether communication is possible or not may be handled by the communication means used, such as networking equipment or the like, or a processor or other controlling unit may make the determination and ensure or facilitate the storing of the event information as well as controlling the later transmission thereof.

In that or another embodiment, the means for having an event identified comprise means for receiving the event as a streamed event and means for, simultaneously to the reception, deriving the one or more parameters. Streamed events may be received in a number of manners, and real-time analysis normally is provided on a processor or the like receiving the streamed event. Often, the event is also streamed to the user at the same time.

It may be desired that the client is adapted to store only the parameter(s) and not the event itself.

In a preferred embodiment, the client further comprises means for providing one or more of the identified events to the user. Providing audio normally would require speakers, and the providing of visual information (images, video) would require a display/monitor or e.g. a printer.

A final aspect of the invention relates to a system for providing events to a user, the system comprising:
1. a client and one or more providers, the client and provider(s) being adapted to communicate with each other,
2. each provider comprising means for accessing information relating to a plurality of events, for each event, the information relates to parameters derived from the event by a predetermined analysis,
3. the client comprises means for holding ID information identifying one or more of the provider(s),
4. the client comprising means for having an event identified and for forwarding event information relating to the identified event to one or more of the provider(s) identified by the ID information,
5. the provider(s) comprising means for identifying events corresponding to the forwarded event information and for returning information identifying the identified events, and
6. the client comprising means for receiving the identifying information and informing the user of the identified events.
   wherein the provider(s) is/are adapted to store the forwarded parameter(s) and, at a later point in time, receive additional information relating to additional events, the identifying means being adapted to identify one or more of the additional events having parameters corresponding to the forwarded parameter(s) and return information identifying the identified, additional events.

Naturally, the storing means etc. may be as those described above.

Preferably, the client further comprising means for providing one or more of the identified events to the user.

In the following, a preferred embodiment of the invention will be described with reference to the appended drawing, which illustrates the main components and actions of this embodiment.

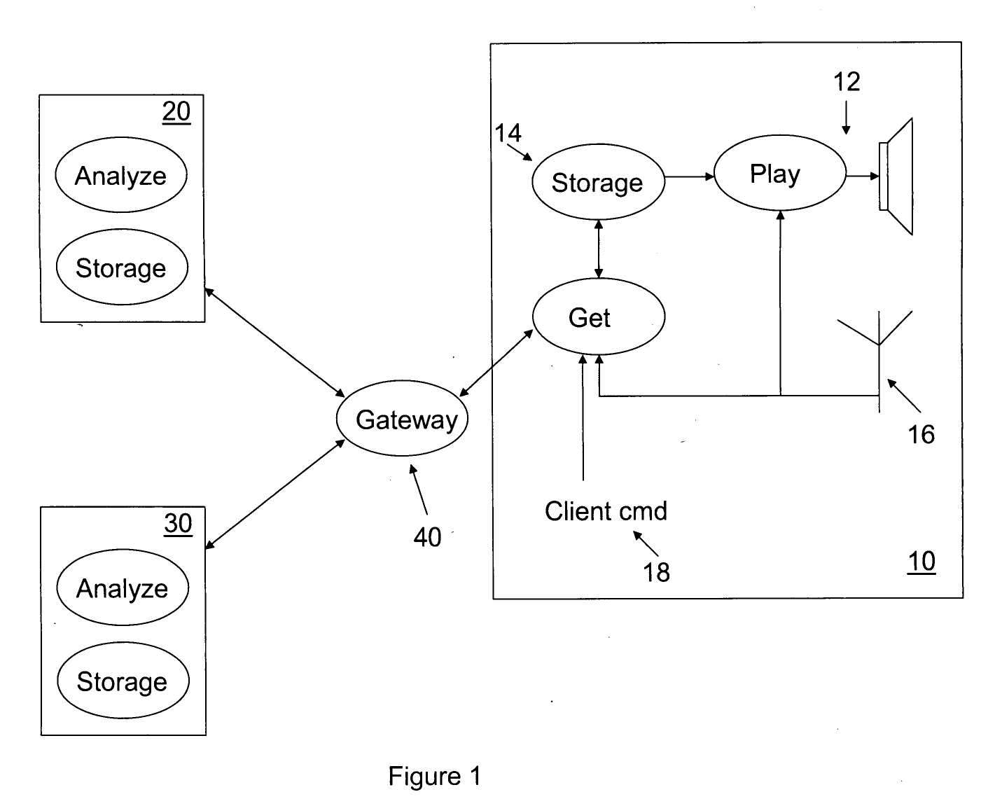

In FIG. 1, a client 10 communicates with two providers 20 and 30 via e.g. WWW, network, LAN, WAN, Ethernet or the like, wireless or not.

In the following, the embodiment will be described with reference to events being music or audio tracks. It will be noted, however, that any type of event may in principle be used with a few modifications, such as the means adapted to provide the event to the user and the manner in which the event is analyzed and the parameter(s) derived and compared.

Also, the invention is described with a single client 10 and two providers 20/30. Any number of clients 10 and providers 20/30 may be used, and each client 10 may communicate with any or all providers 20/30. Also a provider 20/30 may be a client 10 or have the same properties and capabilities, and vice versa.

The client 10 may be a media provider of any type, such as a TV, a radio, a media player, a computer or the like, and has means 12 for providing the event to the user.

In addition, the client 10 may have a storage 14 of any type for holding events directly available thereto as well as instructions determining the operation of the client 10, such as if controlled by a software controllable processor, and for determining the operation performed when and if analyzing an event. This storage 14 may also hold play lists identifying or grouping pluralities of events.

When the means 12 provides an event to the user, such as from the storage 14 or streamed from an external source via the WWW or a receiving means 16, the user may enter a command using means 18, whereby an analysis, performed in the Get-means, of the provided event is performed, if the event has not been pre-analyzed, and parameters derived there from. As described above, the presently preferred analysis is as that described in WO2006/050731.

If the event is received from a streaming source 16, the analysis preferably is performed in real-time, i.e. after the user has entered the input via the means 18 and while at least part of the event is still streamed. It may not be possible or desired to store the streamed event, but this is not required now that the parameter(s) have been obtained. Then, similar events may be obtained either from the storage 14 or as described in the following.

Having derived the parameters from the analysis, these parameters are, together with information identifying one or more of the providers 20 and 30, forwarded to the providers 20 and 30 via a gateway 40, which is not required but is found advantageous.

The identifying information identifies one or more providers 20/30, where the user wishes to search for similar events or at which the user subscribes to interesting events or the like.

The gateway 40 identifies from the information the provider(s) 20/30 to which the parameters are to be transmitted, and forwards the parameter(s) to that provider/those providers.

A provider 20/30 receiving parameter(s) is adapted to access a plurality of events or at least parameters of a plurality of events, so as to be able to identify one or more events similar to that relating to the parameter(s) received.

The provider 20/30 may be adapted to itself analyze accessible events or receive events together with parameters thereof.

The information returned to the gateway 40 may be information relating to one or more events, such as as a playlist of events. Also, the gateway 40 may combine the information received from multiple gateways to a single information package, such as a single playlist. In addition, the client 10 may be adapted to perform an analysis on events stored in its own storage and enter such identified events also in a final list of events including also the events from the gateway.

Naturally, the events identified by the provider(s) 20/30 may be provided directly to the client 10, or information may be forwarded as to how or where to gain access thereto. Optionally, the events may be accessible only upon purchase, lease or the like. Then, the user may accept the charges and subsequently have the events forwarded by or upon interaction by the gateway 40 or provider(s) 20/30.

In one situation, the client 10 is portable, such as a portable MP3/4 player, a car stereo or the like. Then, the communication with the gateway 40 or the providers 20/30 will not be possible at all times. Communication may take place using a wireless network between the gateway 40 and the get-means (or between the get-means and the providers), or may take place via a cabled connection, such as a docking station.

Then, when the client 10 is out of reach of the wireless network or not docked or connected to the cable, no communication may take place. In this situation, event information derived for the providers 20/30 is stored in the storage 14, until communication is again possible, were this information is then transmitted. Similarly, information derived at the providers 20/30 may be stored therein or the gateway 40, if communication to the client 10 is not possible.

Naturally, any amount of information may be stored during the time in which communication is not possible.

In one embodiment, the provider(s) 20/30 may store the parameter(s) received from the client 10. Then, when a provider 20/30 gains access to new or additional events, these events may be analyzed (if not pre-analyzed) and compared to the parameter(s) received, whereby the provider(s) 20/30 act as search engines or search agents now forwarding information relating to events similar to or relevant to parameters which have been forwarded previously.

Thus, each provider 20/30 may hold a number of parameters or search models relating to one or more clients 10 and may continuously, intermittently or upon receipt or access to new or additional events perform the comparison and identification of events. Such parameters or search requests may remain until the user or client 10 decides to withdraw it or may be allowed to lapse after a predetermined period of time.

In another embodiment, the Get-means of the client is not able to perform an analysis of the event but is simply adapted to identify part of or all of the event or information provided with the event (such as meta data transmitted in a streamed signal together with the event) and forward this to the provider(s) 20/30 which then perform the analysis and returns with identification of events, such as a playlist of events.

1. A method of providing events to a user, the method comprising:
1. providing a client available to the user and one or more providers,
2. each provider accessing information relating to a plurality of events, for each event, the information relates to parameters derived from the event by a predetermined analysis,
3. the client holding ID information identifying one or more of the provider(s),
4. the client identifying an event,
5. forwarding event information relating to the identified event to one or more of the provider(s) identified by the ID information,
6. the provider(s) identifying events corresponding to the forwarded event information and returning information identifying the identified events, and
7. the client receiving the identifying information and informing the user of the identified events.
the method further comprising a step, prior to steps 5 and 6, of determining whether communication between the client and provider(s) is possible and, if not, step 4 comprises storing the event information, until communication is possible.

2. A method according to claim 1, wherein step 4. comprises the client deriving one or more parameters from the identified event using the predetermined analysis, and wherein the event information comprises the parameter(s) derived.

3. A method according to claim 2, wherein step 4. comprises the client receiving the event as a streamed event and simultaneously deriving the one or more parameters.

4. A method according to claim 5, further comprising the step of storing only the parameter(s).

5. A method according to claim 1, further comprising the final step of the client gaining access to one or more of the identified events.

6. A method of providing events to a user, the method comprising:
1. providing a client available to the user and one or more providers,
2. each provider accessing information relating to a plurality of events, for each event, the information relates to parameters derived from the event by a predetermined analysis,
3. the client holding ID information identifying one or more of the provider(s),
4. the client identifying an event,
5. forwarding event information relating to the identified event to one or more of the provider(s) identified by the ID information,
6. the provider(s) identifying events corresponding to the forwarded event information and returning information identifying the identified events, and
7. the client receiving the identifying information and informing the user of the identified events,
wherein step 6. comprises the provider(s) storing the forwarded parameter(s) and, at a later point in time, receiving additional information relating to additional events, identifying one or more of the additional events having parameters corresponding to the forwarded parameter(s) and returning information identifying the identified, additional events.

7. A method according to claim 6, further comprising the final step of the client gaining access to one or more of the identified events.

8. A system for providing events to a user, the system comprising:
1. a client and one or more providers, the client and provider(s) being adapted to communicate with each other,
2. each provider comprising means for accessing information relating to a plurality of events, for each event, the information relates to parameters derived from the event by a predetermined analysis,
3. the client comprises means for holding ID information identifying one or more of the provider(s),
4. the client comprising means for having an event identified and for forwarding event information relating to the identified event to one or more of the provider(s) identified by the ID information,
5. the provider(s) comprising means for identifying events corresponding to the forwarded event information and for returning information identifying the identified events, and
6. the client comprising means for receiving the identifying information and informing the user of the identified events.
the system further comprising means for determining whether communication is possible between the client and provider(s) and, if not, storing the event information, until communication is possible.

9. A system according to claim 8, wherein the client further comprises means for deriving one or more parameters from the identified event using the predetermined analysis, the event information comprising the parameter(s) derived.

10. A system according to claim 9, wherein the means for having an event identified comprise means for receiving the event as a streamed event and means for, simultaneously to the reception, deriving the one or more parameters.

11. A system according to claim 10, wherein the client is adapted to store only the parameter(s).

12. A system according to claim 8, the client further comprising means for providing one or more of the identified events to the user.

13. A system for providing events to a user, the system comprising:
1. a client and one or more providers, the client and provider(s) being adapted to communicate with each other,
2. each provider comprising means for accessing information relating to a plurality of events, for each event, the information relates to parameters derived from the event by a predetermined analysis,
3. the client comprises means for holding ID information identifying one or more of the provider(s),
4. the client comprising means for having an event identified and for forwarding event information relating to the identified event to one or more of the provider(s) identified by the ID information,
5. the provider(s) comprising means for identifying events corresponding to the forwarded event information and for returning information identifying the identified events, and
6. the client comprising means for receiving the identifying information and informing the user of the identified events.
wherein the provider(s) is/are adapted to store the forwarded parameter(s) and, at a later point in time, receive additional information relating to additional events, the identifying means being adapted to identify one or more of the additional events having parameters corresponding to the forwarded parameter(s) and return information identifying the identified, additional events.

14. A system according to claim 13, the client further comprising means for providing one or more of the identified events to the user.
